(19) United States
(12) Patent Application Publication
(10) Pub. No.: US 2024/0148025 A1
(43) Pub. Date: May 9, 2024

(54) Protein-rich extrudates, food products, and processes for making the same

(71) Applicant: Teknologian tutkimuskeskus VTT Oy, Espoo (FI)

(72) Inventors: Markus Nikinmaa, Espoo (FI); Lauri Huitula, Espoo (FI); Nesli Sözer, Espoo (FI); Emilia Nordlund, Espoo (FI)

(21) Appl. No.: 18/280,507

(22) PCT Filed: Mar. 8, 2022
(86) PCT No.: PCT/FI2022/050146

§ 371 Date: Sep. 6, 2023

(30) Foreign Application Priority Data
Mar. 8, 2021 (FI) 20215252

(51) Int. Cl. A23J 3/26; A23J 1/12; A23J 1/14; A23J 3/14; A23L 7/17; A23L 11/00

(52) U.S. Cl. CPC A23J 3/26; A23J 1/12; A23J 1/14; A23J 3/14; A23L 7/17; A23L 11/05

(57) ABSTRACT

According to an aspect of the present invention, there is provided a process for forming protein-rich extrudates comprising: (i) extruding a protein-containing source material to form a plurality of protein-rich extrudates and a plurality of non-protein extrudates; and (ii) separating the plurality of protein-rich extrudates from the plurality of non-protein extrudates. The extruded products produced by the above method find industrial application, for example, as additives to food products or stand-alone food products.

### FIELD

The present disclosure relates to protein-rich extrudates, mixtures of protein-rich extrudates and non-protein extrudates, to food products including at least the protein-rich extrudates, and to processes for forming the aforementioned products that include the formation of and separation of the protein-rich extrudates and non-protein extrudates from one another.

### BACKGROUND

There is an increasing interest in concentrated protein products sourced from sustainable plant based raw materials to formulate healthy, appealing, and diverse groups of food products, such as cereals, food bars, pastas, nutritional products, meal substitutes, meat analogues, and ready-to-eat snack products. Given the increase in consumption of such protein products, it is also desirable that such protein concentrates be made efficiently and cost-effectively in large quantities from suitable sources. To date, various processes are known for providing protein concentrates.

For example, wet extraction techniques are known for concentrating a protein fraction which include an extraction or solubilisation step followed by isoelectric precipitation. While highly concentrated protein concentrates are able to be produced, known wet extraction processes require a large amount of water for processing, as well as extensive time and energy for drying processes. Further, due to elevated drying temperatures and the duration thereof, protein denaturation may occur, thereby affecting the quality of the final concentrated protein product. Thus, these wet extraction processes are not cost-effective, especially in large scale production.

On the other hand, dry fractionation techniques are known, wherein a protein-containing material is milled, for example, and then fed into an air classifier which separates the material based on particle size and density, thereby providing a fine fraction which is rich in protein and a coarser fraction which may be rich in a non-protein fraction, such as a starch-containing fraction. While such dry fractionation techniques are energy efficient and maintain the integrity of the protein in the protein fractions, highly concentrated protein fractions are generally not possible (e.g., >50 wt %) and often one must compromise between protein concentration and yield.

There is thus a need for highly concentrated protein products that are easily incorporated into food products or available as in ready-to-eat food products, and which can be made from efficient, cost-effective, and highly scalable processes.

### SUMMARY

The invention is defined by the features of the independent claims. Some specific embodiments are defined in the dependent claims.

According to a first aspect of the present invention, there is provided a process for forming protein-rich extruded products comprising: (i) extruding a source material comprising a protein content and a fat content to form a plurality of protein-rich extrudates and a plurality of non-protein extrudates, e.g., starch-rich extrudates; and (ii) separating the plurality of protein-rich extrudates from the non-protein extrudates. In one aspect, the protein-rich extrudates (fractions) are obtained as a result of a phase separation that occurs during high shearing extrusion without water addition.

In another aspect, there is provided a process for forming protein-rich extruded products comprising: extruding a plant-based source material comprising a protein content and a fat content to form a plurality of protein-rich extrudates having a protein concentration greater than 50 wt % and a plurality of non-protein extrudates having a protein concentration of less than 10 wt %; and separating the plurality of protein-rich extrudates from the plurality of non-protein extrudates.

The inventors have surprisingly found that by extruding source materials comprising a protein content and a fat content, the source material may be formed into distinct protein-rich extrudates and non-protein extrudates, which may easily be separated on the basis of a suitable property or parameter, such as colour, surface texture, hardness, fragility, size, and/or shape, for example. Further, utilizing extrusion in the process for forming protein-rich food pieces is particularly advantageous as minimal drying and water addition are required in the extrusion step.

Moreover, the protein-rich extrudates advantageously have an exceptionally high protein concentration, e.g., at least about 55 wt %, e.g., about 55-about 75 wt % in certain embodiments, and the process has a high yield—due to the efficient separation of extruded protein-rich concentrated extrudates and non-protein extrudates from one another. Without wishing to be bound by theory, it is believed that under extrusion conditions, proteins aggregate to one another due to attractions between disulfide bridges and form individual agglomerates or pieces. These protein-rich extrudates are advantageously able to be separated from non-protein extrudates, e.g., starch-containing extrudates, to provide usable fractions of each. The protein-rich extrudates may be consumed as stand-alone food products or may be utilized within or used in the formation of other food products, such as within baked goods, cereals, plant-based beverages, snack bars, pastas, nutritional products, meal substitutes, meat analogues, or the like. The non-protein extrudates, e.g., starch-containing pieces, may be further utilized as useful products depending on their composition.

In accordance with another aspect of the present invention, there is provided a mixture of a plurality of protein-rich extrudates and a plurality of non-protein extrudates.

In accordance with another aspect, there is provided a mixture comprising a plurality of protein-rich extrudates and a plurality of non-protein extrudates, wherein the protein-rich extrudates comprise a protein concentration greater than 50 wt %, and wherein the non-protein extrudates comprise a protein concentration of less than 10 wt %. In an embodiment, the mixture is from one extrusion of a plant-based source material comprising a protein content and a fat content.

In accordance with yet another aspect, there is provided a protein extrudate comprising at least about 55 wt % protein. In certain embodiments, the protein extrudate is an oat-based protein extrudate.

In accordance with yet another aspect, there is provided a food product comprising a plurality of protein-rich extrudates and/or non-protein extrudates therein.

In accordance with yet another aspect, there is provided a use for the protein-rich extrudates and/or the non-protein rich extrudates as disclosed herein within a food or beverage product or in the production of a food or beverage product.

Next, the present technology will be described more closely with reference to the drawings and certain embodiments.

### BRIEF DESCRIPTION OF THE DRAWINGS

FIG. 1 illustrates a mixture of protein-containing extrudates and non-protein extrudates in accordance with an aspect of the present invention.

FIGS. 2-5 illustrates results from the extrusion of oat flour and faba bean flour into protein-rich extrudates and non-protein extrudates in accordance with an aspect of the present invention.

### EMBODIMENTS

As used herein, the term “non-protein extrudates” refers to extruded pieces resulting from the separation process described herein other than the protein-rich containing pieces that include a protein concentration of less than 10 wt %. It is understood that in the extrusion process, there may be some protein content remaining or which is not separated out from the non-protein extrudates, but the protein concentration is no more than 10 wt % within the non-protein extrudates.

As used herein, the term “protein-rich” refers to extruded pieces that comprise a protein concentration greater than 50 wt % of the total weight of the extruded pieces.

As used herein, the term “extrudates” refers to a material that has been previously subjected to an extrusion process.

As used herein, the term “about” is equal to ±1% of the stated value.

Unless otherwise stated herein or clear from the context, any percentages referred to herein are expressed as percent by weight based on a total weight of the respective composition.

In an embodiment, the fat content of selected materials, e.g., starting materials, was determined using a SoxCap™ 2047 in combination with a Soxtec™ 2050 extraction system with a preparatory acid hydrolysis step and diethyl-ether extraction (Foss A/B, Hillerod, Denmark) according to ISO 6492 (Animal feeding stuffs—Determination of fat content. 1999).

In an embodiment, the protein content of a selected material, e.g., a starting material, the protein-rich extrudates, and/or the non-protein extrudates, was measured by separating the protein-rich extrudates from the non-protein extrudates (if applicable), milling the selected material, and then analyzing the protein content thereof. In an embodiment, protein content was measured by analyzing total nitrogen (N) by the Dumas Combustion method and calculating protein as N×6.25.

To reiterate, according to an aspect of the present invention, there is provided a process for forming protein-rich extruded products comprising: (i) extruding a source material comprising a protein content and a fat content to form a plurality of protein-rich extrudates and a plurality of non-protein extrudates, e.g., starch-concentrated extrudates; and (ii) separating the plurality of protein-rich extrudates from the non-protein extrudates.

In the processes described herein, the source material may comprise any suitable material having a protein content and a fat content that can be extruded into protein-containing extrudates and non-protein-containing extrudates as described herein. The amount of protein in the protein-containing source material naturally leads to and/or provides the desired protein content to the final product (the protein-rich extrudates). In an embodiment, the source material comprises a protein concentration of at least greater than 15 wt %, and in an embodiment least about 20 wt %. In a particular embodiment, the source material comprises a protein concentration of from about 15 to about 25 wt %. In certain embodiments, the protein-containing extrudates comprise at least 65%, at least 70%, or at least 75% of the protein from the source material. In this way, the methods described herein provide for efficient yield of the protein content in the final product.

On the other hand, from extensive testing, the inventors have found that a fat content in the protein-containing source material is necessary for the extrusion and separation steps to be carried out effectively. For example, without a suitable fat content, the extruder die may experience blocked and/or the extruder may require excessive torque.

In an embodiment, the protein-containing source material comprise a fat content of at least about 4 wt %, preferably at least about 5 wt %, for example, about 5 wt % to about 10 wt %. It is contemplated that some source materials may naturally comprise the minimum amount of fat content to enable effective extrusion and separation. By way of example only, oat flours or other oat-based material may have a fat content of about 9 wt %, and thus may be utilized as such without fat addition. In such cases, the source material need not include any fat additives therein in order to be subjected to extrusion. In other embodiments, the source material may comprise a fat additive to provide the source material with the desired amount of fat content to enable the extrusion and separation steps. Thus, in certain embodiments, a fat additive may be added to a precursor source material (e.g., the source material without the fat additive) to provide the source material to be extruded with a fat content of at least about 4 wt %, preferably at least about 5 wt %, such as about 5 to about 10 wt %.

The fat (lipid) additive may comprise any suitable natural or synthetic material to add a desired fat content to the source material. The fat additive can be an oil, including but not limited to canola oil, corn oil, olive oil, canola oil, palm oil, safflower oil, rapeseed oil, soybean oil, mixtures thereof, and the like. The fat additive may also comprise any other fat material, such as fatty acid-esterified propoxylated glycerin compositions, sucrose fatty acid polyesters, or the like.

In certain embodiments, the source material may comprise a plant-based protein source, such as a grain, oilseed, or a legume material. Thus, in certain embodiments, the source material may comprise a grain-based material, such as wheat, rice, oats, cornmeal, barley, rye, or the like, and combinations thereof. Additionally, in certain embodiments, the source material may comprise a legume material, which primarily include globulin proteins. The legume material may comprise one or more of cowpeas, fava beans, alfalfa, clover, beans, peas, chickpeas, lentils, lupins, mesquite, carob, soybeans, peanuts, or the like, and combinations thereof. Without limitation, the source material may thus be derived from soy, peas, wheat, barley, rye, oats, canola, or the like, and combinations thereof. In particular embodiments, the source material may comprise an oat-based material, such as oat flour. The oat flour may be whole grain oat flour or non-whole grain oat flour.

The source material is in a form suitable for extrusion. In an embodiment, the source material in powder form and may comprise a flour or a meal material.

In certain embodiments, an amount of an antioxidant compound may be added to the source material prior to the extruding of the source material to limit or prevent lipid oxidation during the extrusion process. Lipid oxidation may potentially result in rancidity of the extruded products, particularly when extruding at relatively higher extrusion temperatures, e.g., >about 150° C. The antioxidant compound may be any compound or mixture of compounds suitable for limiting or preventing lipid oxidation during extrusion. Exemplary antioxidant compounds include but are not limited to ascorbic acid, tocopherols, or the like. The antioxidant compound may be provided in any suitable effective amount, such as, for example, from 0.01 to 5 wt % of the source material.

In accordance with an aspect of the present invention, the source material is fed to a suitable extruder or extrusion cooking device as is well-known in the art. Typically, extruders include an inlet, an elongated barrel which houses one or more rotatable extrusion screws. The screws help convey food material, e.g., protein-containing source material, introduced into the inlet through the elongated barrel to an outlet. In addition, the heating of the screws or otherwise created in the barrel from friction or heating elements melts the food material. The outlet of the barrel comprises an aperture extrusion die. As extruded material emerges from the extrusion die, the extruded material may be collected. In certain embodiments, one or more cutting devices, e.g., a rotating cutting devices, may also be provided to cut the extruded material into pieces, if desired. In certain embodiments, the extruder may comprise a single screw extruder or a twin screw extruder.

Typically, there is also a build-up of pressure in the barrel, which may be released as the melt exits the die. The pressure release creates an airy porous structure when the melt quickly solidifies as it cools. In this way, the extruded products described herein may comprise expanded food products.

The extruder may be operated under any suitable conditions, e.g., temperature, pressure, moisture content, shear, specific mechanical energy (SME), screw speed, or the like, effective to produce the protein-rich extrudates and non-protein extrudates as described herein.

In certain embodiments, an amount of water may be added to the extruder in addition to the source material to achieve a desired moisture level, if not already present in the source material. An additional aspect of the present invention is that the extrusion process does not require a significant amount of water or liquid to be added for extrusion of the material in the extruder and subsequent separation of the protein-rich extrudates and non-protein extrudates. In certain embodiments, the source material has a moisture content of about 30% or less on a dry basis, and in certain embodiments, about 20% or less on a dry basis during the extrusion process. In an embodiment, the moisture content is at least about 8% or at least about 10% on a dry basis. In certain embodiments, the moisture content is from about 10% to about 15% on a dry basis, and in a particular embodiment from 11% to 15% on a dry basis.

In certain embodiments, the feed rate (mL/min) of water/liquid introduced into the extruder is no more than about 15%, and in certain embodiment no more than about 5% of a feed rate of the source material.

In an embodiment, the extruder comprises one or more temperature zones within the barrel of the extruder, and in certain embodiments, two, three, four, or more distinct temperature zones. In an embodiment, the source material being extruded is heated to a temperature of at least about 100° C. within the extruder, e.g., about 100° to about 200° C., and in certain embodiments at least about 130° C., and in particular embodiments from about 130 to about 170° C., and in further embodiments from about 130° C. to about 160° C. At extrusion temperatures of less than 130° C., the size of the protein-rich extrudates tend to decrease and may reach undesirable levels (depending upon the intended use). At extrusion temperatures greater than 170° C., the protein content of the final protein-rich extrudates may undesirably decrease.

In certain embodiments, the extruder apparatus comprises two or more temperature zones within the barrel of the extruder, wherein a temperature of the material within the temperature zones in increases in a direction from feed to die of the extruder. By way of example only, in an embodiment, the extruder may comprise temperature zones at about 80° C., 95° C., 150° C., and 160° C. from feed to die within the extruder.

The pressure during extrusion may be any suitable pressure to achieve the desired results. In an embodiment, the pressure on the material within the barrel of the extruder is at least about 500 psi (3447 kPa) or at least about 700 psi (4826 kPa) in some embodiments. In particular embodiments, the pressure is from about 700 (4826 kPa) to about 850 psi (5860 kPa). In an embodiment, the pressure is measured at a point before exiting the die of the extruder.

The screw speed may be of any suitable speed to achieve the desired results. In an embodiment, the screw speed is at least about 100 rpm, and in a particular embodiment is at least 200 rpm, and in certain embodiments from about 200 to about 400 rpm.

The specific mechanical energy may be of any suitable speed to achieve the desired results. In an embodiment, the specific mechanical energy (SME) is at least 10 Wh/kg, and in a particular embodiment is at least about 50 Wh/kg, and in certain embodiments at least about 100 Wh/kg, such as from about 100 to about 350 Wh/kg. In a particular embodiment, the extruding is done at a temperature of about 130 to about 160° C., an SME of about 250 to about 300 Wh/kg, and at a moisture content of about 11% to about 15%.

The amount of shear experienced by the material within the extruder may be of any suitable amount to achieve the desired results. In an embodiment, the shear is at least about 50^{s-1}, at least about 100^{s-1}, or at least about 200^{s-1}.

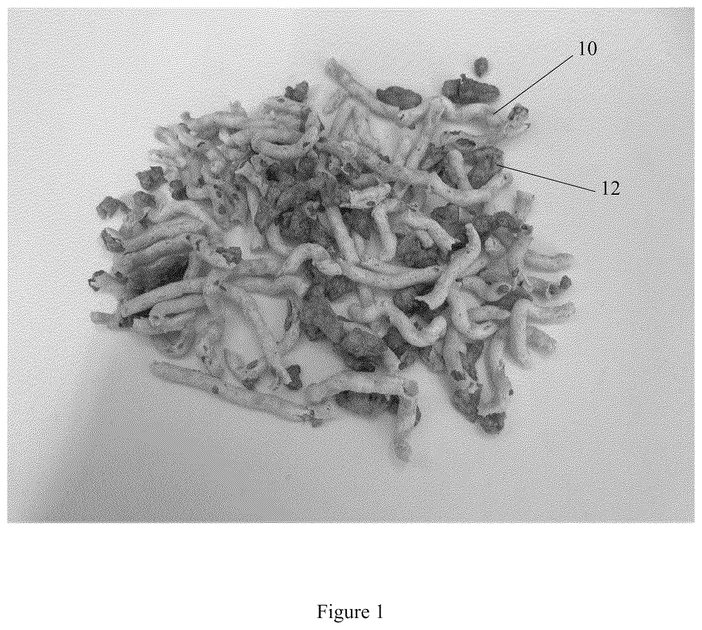

As illustrated in FIG. 1, there is shown exiting from the die of the extruder a plurality of protein-rich extrudates 10 and non-protein extrudates 12. In the embodiment shown, the non-protein extrudates 12 are starch-containing pieces, however, it is understood that the present invention is not so limited. In the embodiment shown, the pieces 10, 12 are clearly different in terms of colour with the protein extrudates being notably darker.

In one embodiment, the protein-rich extrudates 10 and non-protein extrudates 12 can be dry separated from one another. By “dry separated,” it is again meant that no water, solvent, or liquid need be added to the material to be separated in order to effect the separation. In certain embodiments, the protein-rich extrudates 10 and non-protein extrudates 12 can be separated on the basis of surface texture, size, shape, hardness, fragility, and/or any other suitable parameter. Suitable devices and apparatus for carrying out the separation on the basis of colour, surface texture, size, hardness, fragility, shape, and/or other parameter are commercially available and are known in the art for performing the separation step in the present invention.

In other embodiments, the protein-rich extrudates 10 and non-protein extrudates 12 may be separated from one another by a wet separation technique. In one such embodiment, the protein-rich extrudates 10 and non-protein extrudates 12 may be separated via a water-based separation technique. In an embodiment, the water-based technique is any suitable process which is able to separate the extrudates 10, 12 from one another based upon a difference in the dispersibility and/or solubility of the extrudates 10, 12 in water. In an embodiment, for example, the protein-rich extrudates 10 and non-protein extrudates 12 may be soaked in water for an amount of time effective to separate the extrudates 10, 12 from one another. Generally, the protein-rich extrudates 10 are insoluble in water while the non-protein extrudates 12 are dispersed or solubilized in water to enable the separation of the extrudates 10, 12 from one another.

The protein-rich extrudates advantageously comprise pieces (individually) having a protein concentration of at least greater than 50 wt %, at least about 55 wt %, at least 60 about wt %, or at least about 65 wt %. In a particular embodiment, the protein-rich extrudates comprise a protein concentration of from about 68 to about 85 wt %.

In certain embodiments, the protein-rich extrudates may comprise a fat content of at least about 2 wt % or at least about 4 wt %. In certain embodiments, the fat content of the protein-rich extrudates may be from about 2 wt % to about 8 wt %, preferably from about 3 wt % to about 6 wt %. It is contemplated that some of the initial fat content from the source material may be separated and carried into the non-protein extrudates.

Further, the protein-rich extrudates may comprise any suitable size and shape. In certain embodiments, the protein-rich extrudates have an irregular shape. The extruded-protein rich pieces may have a longest dimension of at least about 1 cm, and in certain embodiments from about 1 cm to about 20 cm. In certain embodiments, the extruded protein-rich may further be reduced in size, such as by grinding, milling, or the like.

In certain embodiments, the protein-rich extrudates comprise legume-based or grain-based extruded pieces having a protein concentration of at least about 65 wt %, and in certain embodiments at least about 68 wt %. In particular embodiments, the protein-rich extrudates comprise oat-based extrudates derived from an oat-based material, e.g., oat flour.

In certain embodiments, the non-protein extrudates may have a desired utility of their own. For example, the non-protein extrudates may comprise starch-containing pieces. In certain embodiments, the starch-containing pieces individually comprise a starch concentration of greater than about 50 wt %. In certain embodiments, the starch concentration is at least about 60 wt %, and in certain embodiments is at least about 65 wt %. In certain embodiments, the starch-containing pieces may be incorporated into food and/or non-food products as a filler or a binding agent. In other embodiments, the non-protein extrudates may comprise a fat content instead of or in addition to a starch content.

The protein-rich extrudates and/or non-protein extrudates may be consumed as stand-alone food products or may be incorporated within or used in the formation of other food products. In certain embodiments, as stand-alone food products, the extruded protein pieces may be packaged and sold in bulk quantities or packaged for use as toppings for yogurt or the like. In other embodiments, the extruded protein pieces may be in a form ready for incorporation into foods without further processing, such as snack mixes with nuts, dried fruits, candy pieces and the like. In still other embodiments, the protein-rich extrudates are in a form such that they may be immediately utilized in the formation of food products, such as meat analogues and snack bars. In still other embodiments, the non-protein pieces, e.g., starch, may be utilized as filler material or the like. In further embodiments, the protein-rich extrudates may be used as additives in plant-based drinks, such as oat milks or the like.

### Examples

Example 1: Oat flour was fed into an APV Baker MPF 19/25 extruder at ca 60 g/min. The protein content of the starting material was about 19.2 wt %. An amount of water was added in the water feed (ca 2 g/min) in the beginning of the barrel. The flour was processed at a temperature of 130-170° C. at the end of the extruder, at about 14% moisture, and with a screw speed of 250-450 rpm. The material left the die as two fractions. With a temperature profile of 150-140-95-80° C. (die to feed), a protein content of 73 wt % at a yield of 71.5% of total protein in the protein-rich extrudates (fraction) was obtained. With a temperature profile of 130-120-95-80° C. (die to feed), a slightly higher protein content and yield (75% and 73% respectively) were obtained, although the size of the protein-rich extrudates (fraction) was smaller.

After extrusion, the protein-rich extrudates and non-protein extrudates (e.g., starch-rich fraction in this example) were mixed with water for separation, which caused the starch-rich fraction to disperse into a slurry while the protein rich fraction remained solid. The starch-rich fraction was then separated from the protein-rich fraction by sieving. During sieving, the dispersed starch-rich fraction traveled through the sieve while the solid protein-rich fraction was retained in the sieve. The protein-rich extrudates were dried and analysed for protein content (about 73-75 wt %), and a protein yield was calculated. In the present examples, 71.5-73% of the total protein in the starting material was recovered. The remainder of the protein was most likely in the dispersed phase.

Example 2: Faba been flour was also processed to provide protein-rich extrudates as described. The starting faba bean material had a protein content of 29.5 wt % protein. Due to the low fat content, 10 wt % fat was added to the flour before extrusion and then extruded under the same conditions as in Example 1. The final protein-rich extrudates had a protein content of about 68 wt %.

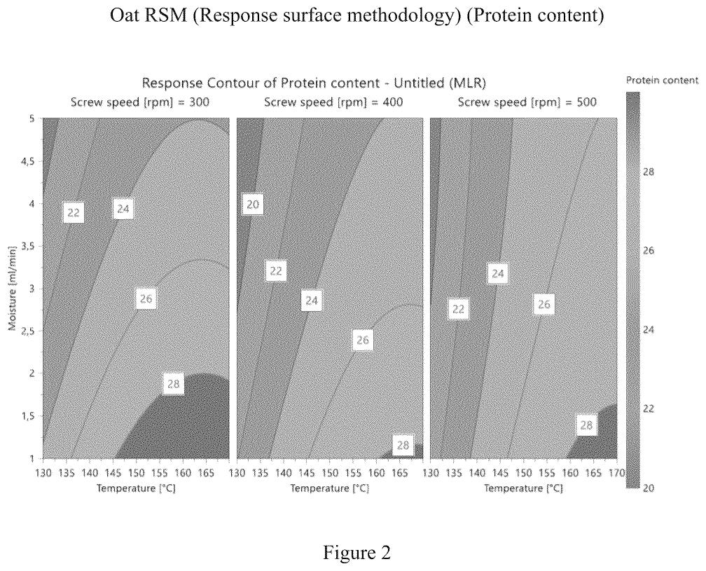

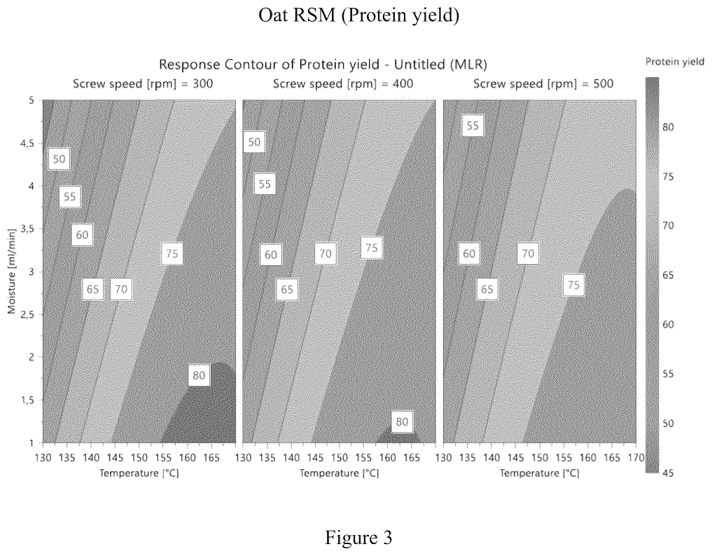

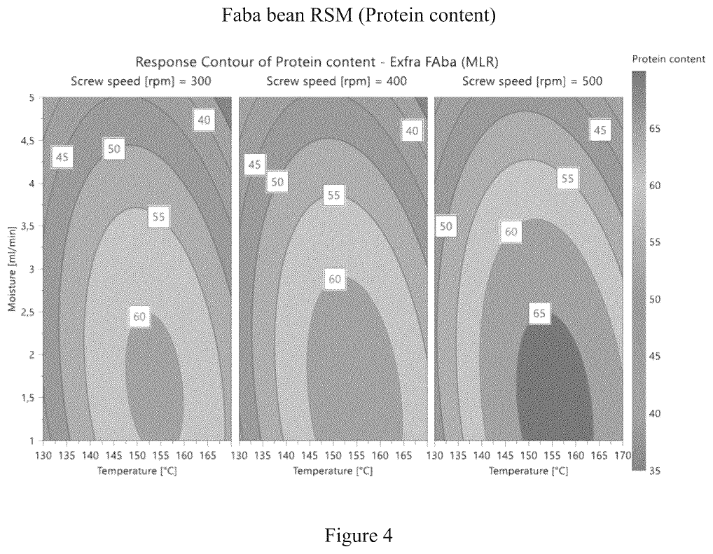

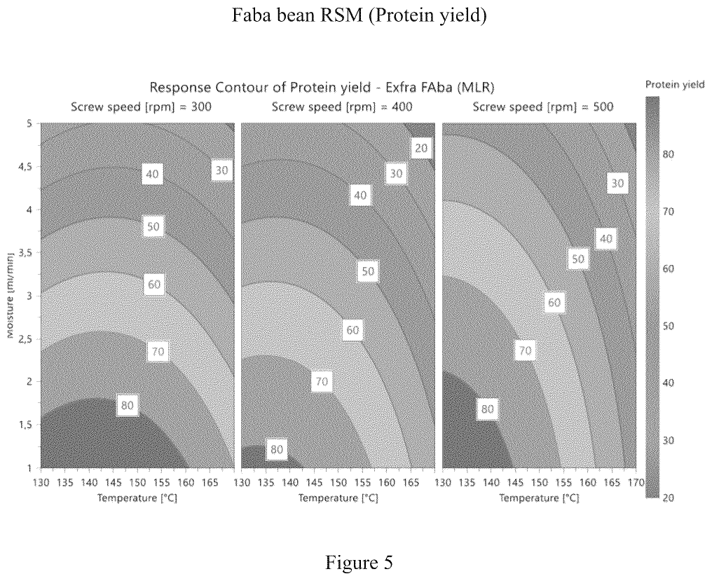

Example 3: A plurality of trials were run with oat flour and faba bean flour within/as the starting materials. The initial protein content for the oat flour was 18.9 wt %. The fat content in oat starting material was 8 wt %. The initial protein content for the faba bean flour (with 5 wt % oil added) was 32.7 wt %. While not measured, prior to oil addition, the faba bean flour likely had a fat content of about 1.5-2 wt %. The materials were extruded under various conditions as shown in FIGS. 2-5. In the Figures, the Y-axis represents added moisture. In the trials, the starting moisture was about 10%. Total moisture for both oat and faba bean materials were 11.5-14%.

After extrusion, protein-rich extrudates were separated from non-protein extrudates by a wet process. In particular, the extrudates were soaked in hot water, which led to the non-protein extrudates dispersing in the water due their significant starch content, while the protein-rich extrudates did not. Thereafter, the protein-rich fractions were collected in a sieve, while the liquid-containing starch material traveled through the sieve. Protein yield was calculated as a ratio of the total protein in the separated fraction (protein-rich extrudates):total protein in starting material—i.e., the share of the total protein going into the protein-rich fraction. In certain embodiments, an amount of amalyse may be added to extruded contents as described herein to degrade residual starch (if present).

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an,” that is, a singular form, throughout this document does not exclude a plurality.

### INDUSTRIAL APPLICABILITY

The present method and the products thereby produced find industrial application, for example, as stand-alone food products, e.g., snacks, and/or as additives or for making food products

### CITATION LIST

### Patent Literature

EP 3 155 903 A1
US 2020/0196630
US 2012/0171351
U.S. Pat. No. 7,709,033

1. A process for forming protein-rich extruded products comprising:
extruding a plant-based source material comprising a protein content and a fat content to form a plurality of protein-rich extrudates having a protein concentration greater than 50 wt % and a plurality of non-protein extrudates having a protein concentration of less than 10 wt %; and
separating the plurality of protein-rich extrudates from the plurality of non-protein extrudates.

2. The process of claim 1, wherein:
the plurality of protein-rich extrudates have a protein concentration of at least about 55 wt %.

3. The process of claim 1, wherein:
the separating is done on the basis of size, shape, surface texture, color, hardness, fragility, or combinations thereof.

4. The process of claim 3, wherein:
the separating is done on the basis of color of the plurality of protein-rich extrudates and the plurality of non-protein extrudates.

5. The process of claim 1, wherein:
the separating is done by a water-based separation technique.

6. The process of claim 1, wherein:
the source material comprises a plant-based protein source comprises a legume, an oilseed material, or a grain material.

7. The process of claim 1, wherein:
the source material comprises an oat material.

8. The process of claim 1, wherein:
the plant-based source material comprises a fat content of about 5 wt % to about 10 wt %.

9. The process of claim 1, wherein:
the plurality of non-protein extrudates comprise starch-containing extrudates.

10. The process of claim 1, wherein:
the plant-based source material is provided by adding a fat additive to a precursor plant-based source material.

11. The process of claim 1, wherein the process further comprises:
adding an antioxidant compound to the plant-based source material prior to the extruding to limit or prevent lipid oxidation during the extruding.

12. The process of claim 1, wherein:
the extruding is done at a temperature of about 130 to about 160° C., a specific mechanical energy of about 250 to about 300 Wh/kg, and at a moisture content of about 11% to about 15%.

13. A mixture comprising a plurality of protein-rich extrudates and a plurality of non-protein extrudates, wherein the protein-rich extrudates comprise a protein concentration greater than 50 wt %, and wherein the non-protein extrudates comprise a protein concentration of less than 10 wt %.

14. The mixture of claim 13, wherein the mixture is from one extrusion of a plant-based source material comprising a protein content and a fat content.

15. The mixture of claim 13, wherein:
the plurality of protein-rich extrudates have a protein concentration of at least 65 wt %.

16. The mixture of claim 13, wherein:
the mixture of protein-rich extrudates and non-protein extrudates are extruded from a-a legume, an oilseed, or a grain material.

17. The mixture of claim 13, wherein:
the mixture of protein-rich extrudates and non-protein extrudates are extruded from an oat material.

18. The mixture of claim 13, wherein:
the protein-rich extrudates have a fat content of from about 2 wt % to about 8 wt %.

19. A food or beverage product comprising the protein-rich extrudates and/or the non-protein rich extrudates of claim 13 therein.

20. (canceled)

21. The process of claim 1, wherein:
the plant-based source material comprises a fat content of at least 4 wt %.
